(19) United States
(12) Patent Application Publication
(10) Pub. No.: US 2003/0225859 A1
(43) Pub. Date: Dec. 4, 2003

(54) Request mapping for load balancing

(75) Inventors: Sanjay Radia, Fremont, CA (US); Saveen Pakala, Milpitas, CA (US); Devendra Jaisinghani, Fremont, CA (US); Kumar Ramaswamy, San Jose, CA (US)

Correspondence Address: John F. Nethery, SONNENSCHEIN NATH & ROSENTHAL, P.O. Box #061080, Wacker Drive Station, Sears Tower, Chicago, IL, 60606-1080, US

(73) Assignee: SUN MICROSYSTEMS, INC.

(21) Appl. No.: 10/159,191

(22) Filed: May 31, 2002

(51) Int. Cl. G06F 15/163; G06F 9/54; G06F 9/00; G06F 15/173; G06F 15/16

(52) U.S. Cl. 709/219; 709/243

(57) ABSTRACT

A request mapping technique allows a layer 4 load balancing process to operate, effectively, based on layer 7 information. Thus, the request mapping technique helps a load balancer forward information requests to appropriate information servers based on high level information.

### BACKGROUND OF THE INVENTION

1. Field of the Invention

This invention relates to load balancing in data processing systems. In particular, this invention relates to distributing work load among multiple information servers based on requested content.

2. Description of the Related Art

It is often the case that data centers serving large volumes of information are implemented using multiple servers. Each server helps meet part of the demand for the data by independently responding to a fraction of the total number of incoming information requests. Thus, for example, a popular website may be implemented with many servers that carry identical content, each of which may respond to requests from many remote users.

A multiple server implementation of a data center is generally accompanied by a load balancing technique. The load balancing technique distributes the workload (e.g., processing of and responding to remote user information requests) among the multiple servers according to some preselected criteria. For example, the load balancing technique may distribute workload according to the current CPU utilization of each server.

When the data center is part of a network that adheres to a multiple layer networking model, the load balancing may occur based on the layers. For example, the network may be a TCP/IP packet network that adheres to the ISO 7-layer reference model. Load balancing may then occur based on information available at layer 4, the Transport layer. As examples, a layer 4 load balancer may distribute workload based on the Internet Protocol (IP) address and Transmission Control Protocol (TCP) port present in received TCP/IP compliant packets.

Layer 4 load balancing is very fast due in part to its implementation in hardware. However, layer 4 load balancing operated at a very low level that was not appropriate for all purposes. Specifically, the IP address did not provide more than a raw machine address, and the TCP port was commonly fixed at 80 to indicate a web server port. Thus, attempts have been made to focus instead on information available at a higher level in the reference model, for example, layer 7, the Application layer.

At layer 7, additional information is available that characterizes the information requests. For example, an entire HTTP header, including a server name, directory path, and a file name is often at hand. Thus, a layer 7 load balancer may specifically distribute workload based on which of the multiple servers is most appropriate for serving the information requested in the HTTP header. Unfortunately, layer 7 load balancing posed significant performance problems for several reasons. First, processing information at a higher level of the model inherently requires more processing. Second, a layer 7 load balancer had to terminate TCP connections in order to process subsequent high level protocol packets (for example, HTTP headers). Thus, a layer 7 load balancer not only introduced latency, but was also a bottleneck of high level processing.

Therefore, a need has long existed for a load balancing technique that overcomes the problems noted above and others previously experienced.

### SUMMARY OF THE INVENTION

Methods and systems consistent with the present invention provide an information request mapping technique by which a lower level (e.g., layer 4) load balancing process may operate, effectively, based on higher level (e.g., layer 7) information. Lower level load balancers are typically implemented in fast hardware. Thus, the request mapping technique helps a data center achieve the benefits of higher level load balancing at the performance level of a lower level load balancer.

According to one aspect of the present invention, such methods and systems, as embodied and broadly described herein, include identifying requested content in an information request, determining the server designated to serve that requested content, determining an information-identifier modification (e.g., adding a port number) to designate a particular server to server particular content, modifying information-identifiers contained in the requested content (e.g., embedded URLs) with additional information that will assist in subsequent request processing, and returning to the requestor the requested content and Modified Information-identifiers (e.g., modified URL links) changed according to the modification. As a result, a subsequent information request that stems from activation (e.g., by clicking on the URL link) of the Modified Information-identifier includes the modification that designates a particular information server for handling the requested information. A load balancer may then quickly forward the subsequent information request to the designated server based on the modification without incurring the processing costs of a higher level (e.g., layer 7) load balancing process.

Methods and systems consistent with the present invention modify an Information-identifier to particularly designate an information server for responding to an information request. The Modified Information-identifier may be used by a low level (e.g., layer 4) load balancer to quickly direct an information request to the appropriate server based, essentially, on high level information. Thus, a relatively slow layer 7 load balancer need not be implemented to forward the information requests with additional higher level processing overhead. Rather, a relatively fast layer 4 load balancer may instead quickly direct the information requests to the designated servers.

A method consistent with the present invention includes receiving an information request from a requester, determining a designated server for handling the information request, and determining a modification (e.g., adding a port number) for the designated server. In addition, the method includes modifying the information-identifiers (e.g., embedded web page URLs) to form Modified Information-identifiers, and returning the requested content including the Modified Information-identifiers to the requester.

A data processing system (e.g., that implements an information server) consistent with the present invention includes a memory that holds a request mapping program. The request mapping program analyzes an information request received from a requester to identify requested content, determines a designated server for serving the requested content, modifies information-identifiers to form Modified Information-identifiers that designate an information server for handling the requested content, and returns the requested content including the Modified Information-identifiers to the requester. A processor runs the request mapping program.

A computer-readable medium consistent with the present invention is also provided. The computer-readable medium contains instructions that cause a data processing system to perform a method. The method includes determining a designated server for handling an information request, determining a modification for specifying the designated server, modifying information-identifiers to form an Modified Information-identifiers, and returning the requested content including the Modified Information-identifiers to the requester.

Other apparatus, methods, features and advantages of the present invention will be or will become apparent to one with skill in the art upon examination of the following figures and detailed description. It is intended that all such additional systems, methods, features and advantages be included within this description, be within the scope of the present invention, and be protected by the accompanying drawings.

### BRIEF DESCRIPTION OF THE DRAWINGS

FIG. 1 depicts a block diagram of a data processing system suitable for practicing methods and implementing systems consistent with the present invention.

FIG. 2 depicts a data center connected to a remote requester, including a load balancer and information servers that may be implemented as shown in the data processing system block diagram of FIG. 1.

FIG. 3 depicts examples of information requests and Modified Information-identifiers analyzed and formed by an information request mapping program running in the information servers shown in FIG. 2.

FIG. 4 depicts a flow diagram showing processing performed by the load balancer and by the request mapping program running in the information servers shown in FIG. 2 in order to analyze information requests and form Modified Information-identifiers.

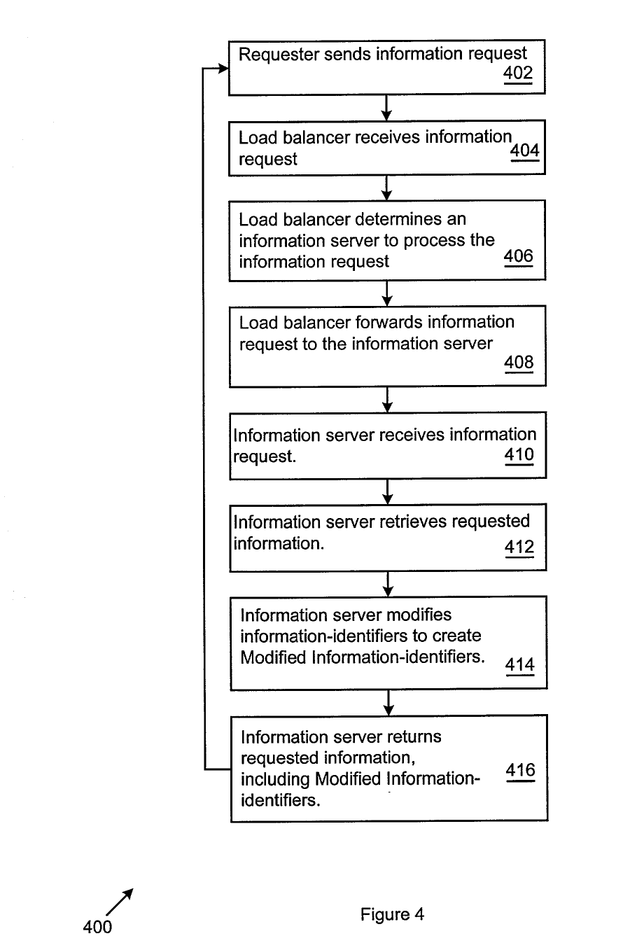

### DETAILED DESCRIPTION OF THE INVENTION

Reference will now be made in detail to an implementation in accordance with methods, systems, and products consistent with the present invention as illustrated in the accompanying drawings. The same reference numbers may be used throughout the drawings and the following description to refer to the same or like parts.

As an initial matter, it is noted that although the discussion below proceeds with reference to the Hypertext Transfer Protocol (HTTP), Uniform Resource Locators (URLs) and the Transport Control Protocol/Internet Protocol (TCP/IP), methods and systems consistent with the invention are not limited those protocols. Rather, the methods and systems are applicable to other protocols (e.g., File Transfer Protocol (FTP)), and more generally, to any data processing systems that respond to requests for information. Furthermore, although adding a port number is often used as an example of a modification to an information-identifier such that the Modified Information-identifier identifies a particular server for handling requests for a particular subset of information, it is noted that the modification may instead or additionally add to or modify any component of the URL alone or in combination.

As examples, given the URL http://www.website.com:80, a port number may be changed (e.g., http://www.website.com:27652), a specific server name may be added (e.g., http://www.server1.website.com:80), or an IP address may be added (e.g., http://10.1.1.102:80).

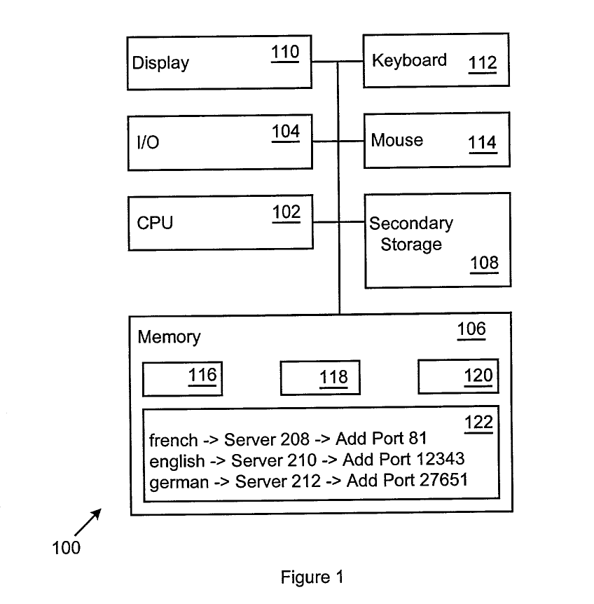

FIG. 1 depicts a block diagram of a data processing system 100 suitable for practicing methods and implementing systems consistent with the present invention (e.g., in an information server). The data processing system 100 comprises a central processing unit (CPU) 102, an input output I/O unit 104, a memory 106, a secondary storage device 108, and optionally a video display 110. The data processing system 100 may further include input devices such as a keyboard 112 or a mouse 114.

The memory 106 contains a request mapping program 116 that analyzes an information request 118 to form a Modified Information-identifier 120. The Modified Information-identifier 120 includes information that assists a low level load balancer to quickly direct information requests to a designated information server. To that end, the request mapping program 116 consults the contents of a content mapping database 122. The content mapping database 122 includes content entries (e.g., French, English, and German) associated with designated servers (e.g., Server 208, Server 210, and Server 212) and extension information (in this case the preselected port numbers 81, 12343, and 27651). The request mapping program 116 may be part of an operating system, a program independent of the operating system, or routines incorporated into another program (e.g., a web server application).

Although aspects of the present invention are depicted as being stored in memory 106, one skilled in the art will appreciate that all or part of systems and methods consistent with the present invention may be stored on or read from other computer-readable media, for example, secondary storage devices such as hard disks, floppy disks, and CD-ROMs; a signal received from a network such as the Internet; or other forms of ROM or RAM either currently known or later developed. Further, although specific components of data processing system 100 are described, one skilled in the art will appreciate that a data processing system suitable for use with methods, systems, and articles of manufacture consistent with the present invention may contain additional or different components.

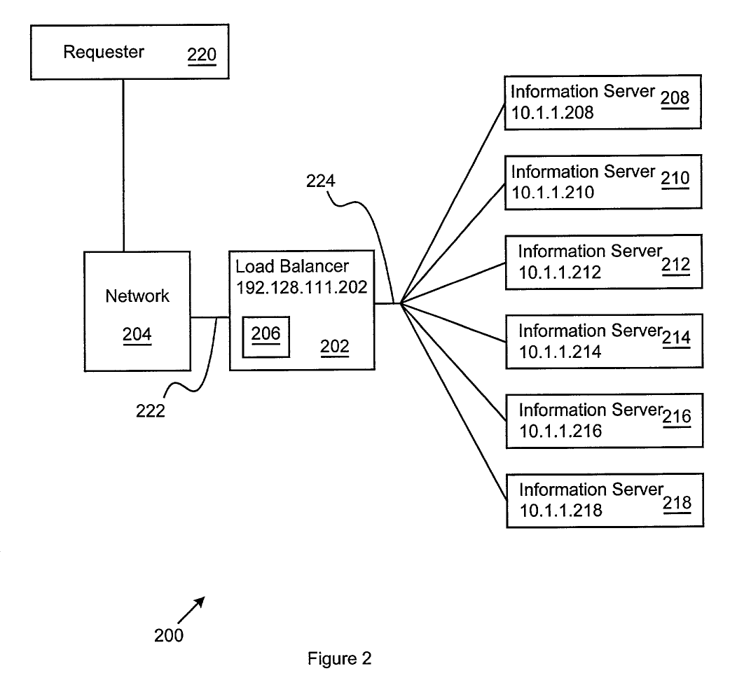

Turning next to FIG. 2, that figure depicts a data center 200. The data center 200 includes the load balancer 202 and the information servers 208-218. The data center 200 connects through the load balancer 202 to a network 204 (e.g., the Internet, a LAN/WAN, or the like) and a requestor 220. The load balancer 202 consults a mapping table 206 to determine which of the information servers 208-218 should receive an information request that the load balancer receives from the requester 220. Although six information servers 208-218 and one requester 220 are illustrated, the number of information servers may vary widely depending on the implementation, and there may be virtually any number of requesters 220.

The requesters 220 may represent remote personal computers running Internet browsers, programs or processes such as automated file request programs, and the like. The information servers 208-218 may be regarded as hardware entities (e.g., individual machines), or may be regarded as instances of Web application or server software running on the hardware. In the later case, any individual data processing system may execute multiple information servers.

Note that the load balancer 202 and the information servers 208-218 may be implemented as shown in FIG. 1. In other words, the load balancer 202 and the information servers 208-218 may each include a CPU, memory, I/O, secondary storage, input devices, and the like. The specific operation of the load balancer 202 and the information servers 208-218 will be discussed in more detail below.

The load balancer 202 connects to the network 204 over the network connection 222. Similarly, the load balancer 202 connects to the information servers 208-218 over the server connection 224. The network connection 222 and server connection 224 may be implemented as TCP/IP compliant Ethernet network links, for example. Thus, the load balancer 202 and the information servers 208-218 may be assigned Internet Protocol (IP) addresses. In the example shown in FIG. 2, the IP address for the load balancer 202 is 192.128.111.202 and the IP addresses for the information servers 208-218 are 10.1.1.208-10.1.1.218.

The load balancer 202 is the front end for the set of information servers 208-218 that respond to information requests from the requester 220. The load balancer IP address is referred to as a Virtual IP (VIP) address because although it is assigned to the load balancer 202, it is used by requesters to retrieve content from the information servers 208-218 behind the load balancer. As a result, requesters 220 appear to retrieve content directly from a virtual information server addressed by the VIP address.

In reality, however, the information requests first arrive at the load balancer 202. The load balancer 202 subsequently distributes the information requests to the information servers 208-218. As a result, the IP addresses assigned to the information servers 208-218 need not be reachable from the network 204; rather, they are reachable from the load balancer 202. The load balancer 202 directs information requests to an information server 208-218 based in part on a port number included with information accompanying the information request.

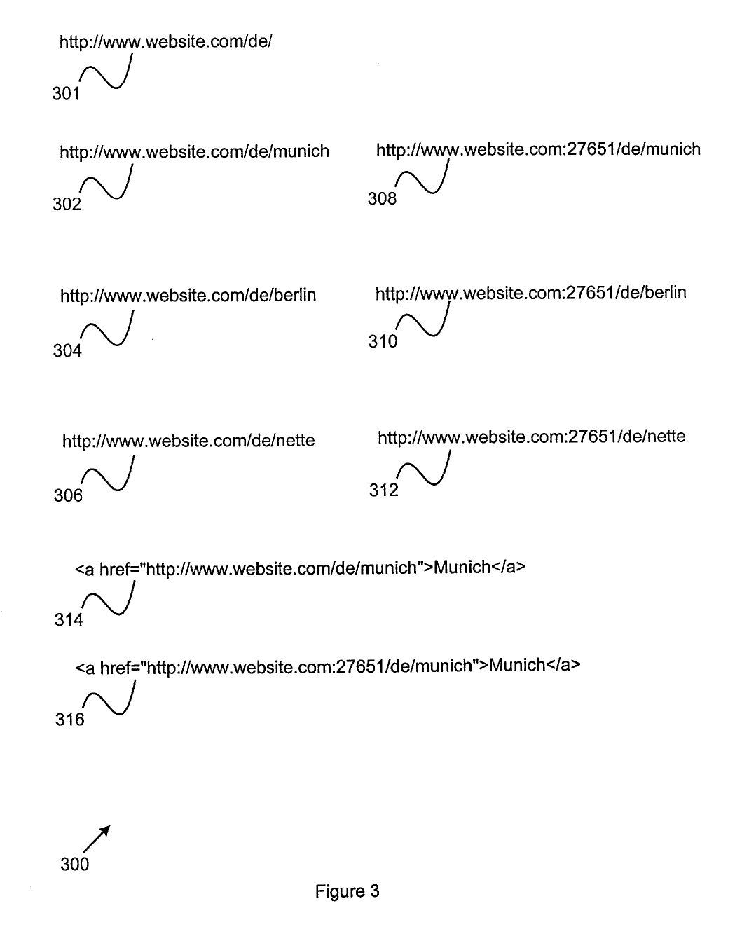

When an information server 208-218 receives an information request, the request mapping program 116 analyzes the information request to determine the requested content. With regard to the example shown in FIG. 3, the request mapping program 116 analyzes, for example, the characters or other indicia present in protocol packets, HTTP header fields, URLs, and the like to determine the requested content. Thus, for example, the “/de/” text in the information request 301 and the information-identifiers 302-306 identifies German requested content. Once the request mapping program 116 determines the requested content, the request mapping program 116 consults the mapping database 122 to determine one or more designated servers for the requested content.

As shown in FIG. 1, for example, the mapping database 122 includes a content entry that specifies that the information server 212 is designated to handle German content. In addition, the request mapping program 116 consults the mapping database 122 to obtain a modification (e.g., adding a port number) that has been assigned to the designated server. In this instance, a port entry in the mapping database 122 associates the port number 27651 with the information server 212. More specifically, the mapping database 122 typically stores the IP address of the information server 212 and the assigned port number.

As explained in more detail below, the mapping table 206 in the load balancer 202 includes entries that direct the load balancer 202 to forward information requests that specify port number 27651 to the information server 212. Thus, the mapping database 122 pairs the server serving “German” content with the 2-tuple (Virtual IP address, port number “27651”). As noted above, the request mapping program 116 determines the port number 27651 for the information server 212 that has been designated to serve German content.

Next, the request mapping program modifies information-identifiers (in this case, by adding a port number) to form Modified Information-identifiers. As shown in FIG. 3, for example, the information identifiers 302-306 (that provide links to information on German cities) have been modified to be Modified Information-identifiers 308, 310, and 312. Specifically, the request mapping program 116 has rewritten the information identifiers 302-306 to form the Modified Information-identifiers 308-312 that include the port number 27651 after the domain name “www.website.com”.

The information-identifiers 302-306 may, for example, be embedded as links in web pages that include the information content requested. In other words, the information identifiers 302-306 may, as one example, be present in the webpage specified by the information request 301. As a specific example, the information-identifier 302 may be represented as a link in the webpage using an HTML href structure 314. The request mapping program 116 may then modify the information-identifier 302 to form the modified HTML href structure 316. Generally, the request mapping program 116 rewrites information-identifiers as Modified Information-identifiers, then returns the web page content including the Modified Information-identifiers.

The request mapping program 116 may modify as many information-identifiers as it can, depending on the extent of content information that it has. Thus, for example, an information server that knows only that it is supposed to server German content will recognize and rewrite only information-identifiers that specify German content. On the other hand, an information server that can recognize information-identifiers for other types of specific content can also modify those information-identifiers to specify an appropriate server for handling the specific content.

Thus, the requester 220 receives the requested information as well as the Modified Information-identifiers embedded within the requested information. As a result, subsequent information requests arising from activating the Modified Information-identifiers (e.g., by clicking on a link specified by a Modified Information-identifier in a web page) include the modification (e.g., they include the port number) that the load balancer 202 uses to direct the information request to the particular information server designated to handle the information.

In particular, the specific port number is included in the TCP message that bears the information request arising from activation of a Modified Information-identifier. Thus, when the subsequent information requests arrive at the load balancer 202, the load balancer 202 forwards the information requests directly to the designated information server 212 in accordance with the entries in the mapping table 206.

In effect, the Original Information-identifiers include high level information about the content requested (e.g., in the form of URL strings that identify specific content). The request mapping program 116 maps these Original Information-identifiers containing high level information to Modified Information-identifiers that contain corresponding lower level entities (e.g., port number) that can be used by the load balancer 202 operating at a lower layer (e.g., Layer 4) for much more efficient load balancing. Thus, high level (e.g., Layer 7) load balancing is achieved at a lower level (e.g., Layer 4), with attendant speed benefits.

The determination of requested content need not be limited to language. Rather, any distinguishing characteristic may be used to direct information requests to designated servers. For example the requested content may vary by subject area (e.g., science, sports, or local news), by locality (e.g., United States, Europe, or South America), and the like.

Note that even though specific servers are designated to handle certain content, in many implementations each information server 208-218 will include a complete copy of the information available from the data center 200. Thus, when an initial information request arrives without a modification (e.g., without specifying a specific port number), any information server 208-218 that receives the initial information request may respond with the appropriate information, in addition to forming the Modified Information-identifier so that subsequent information requests are directed to the designated server.

The information servers 208-218 respond to the requester 220 with the requested information. In doing so, the information servers 208-218 may respond through the load balancer 202 to the network 204, or may respond directly to the network 204. The network 204, in turn, routes the response to the requester 220.

The request mapping technique works in concert with the load balancer 202. More specifically, the load balancer 202 receives information requests via the network 204 and distributes them to the information servers 208-218. The load balancer 202 determines to which information server 208-218 each information request received from the network 204 will be forwarded.

To that end, the load balancer 202 consults the mapping table 206. For example, the mapping table 206 may include the entries shown below in Table 1:

TABLE 1

| Virtual | |
|---|---|
| IP address:Virtual Port Number | Real IP address:Real Port Number |
| 192.128.111.202:81 | 10.1.1.208:80 |
| 192.128.111.202:12343 | 10.1.1.210:80 |
| 192.128.111.202:27651 | 10.1.1.212:80 |

Each information request served by the information servers 208-218 is accompanied (e.g., in a TCP header) by the VIP address associated with the data center 200 but physically assigned to the load balancer 202. The information request (e.g., for the German content of a website) may be specified by a URL (e.g., http:www.website.com/de) or HTTP header. HTTP headers are described in more detail in the HTTP/1.1 specification available from the World Wide Web Consortium (W3C) at www.w3.org/Protocols.

In a TCP/IP based network, the information request is wrapped in a Transport Control Protocol (TCP) message that specifies the VIP address and a port number. Based on the mapping table 206, the load balancer 202 directs information requests to an information server 208-218 based on the port number included with the information request. Thus, an information request that includes the port number 27651 is directed to the information server with IP address 10.1.1.212, port 80 (i.e., the information server 212).

Early in the development of the World Wide Web, port 80 became widely used to generally designate HTTP traffic. However, while in some cases port 80 is used to designate HTTP traffic, port 80 does not distinguish between any type of traffic. On the other hand, as described above, the request mapping program 116 (e.g., running on the information servers 208-218 or the load balancer 202) will add a specific port number (not limited to port 80) to information requests. The port number is specific in that it has been designated to represent one or more types of specific requested information. For instance, in the example used above, port 27651 was specific to German content. As a result, the load balancer 202 routes subsequent information requests directly to a designated server assigned to serve the content requested.

The processing steps explained above are summarized in the flow diagram 400. A requester 220 sends an information request, for example, in the form of a URL (Step 402). The load balancer 202 receives the information request (Step 404). The load balancer 202 then determines an information server to process the information request (Step 406), and forwards the information request to the information server (Step 408).

The information server receives the information request (Step 410) and retrieves the requested information (Step 412). As explained in detail above, a request mapping program in the information server modifies information-identifiers to form Modified Information-identifiers (Step 414). The information server then returns both the requested information, and the Modified Information-identifiers to the requester 220 (Step 416).

One information server 208-218 may handle multiple types of content. On the other hand, multiple information servers 208-218 may handle one type of content. Regardless, the mapping table 206 may be configured to appropriately direct the related information requests. For example, Table 2 shows how the mapping table 206 may be set up to distribute information requests for one type of content to multiple information servers. Such a configuration provides an important benefit of availability in that as long as at least one of the information servers is functional, the service as a whole is available. In other words, if N servers are configured to serve identical content, the service is up as long as no more than N-1 servers fail at a given instance.

TABLE 2

| Virtual | |
|---|---|
| IP address:Virtual Port Number | Real IP Address:Real Port Number |
| 192.128.111.202:27651 | 10.1.1.210:80 |
| 192.128.111.202:27651 | 10.1.1.212:80 |

As another example, Table 3 shows how the mapping table 206 may be set up to distribute information requests for multiple types of content to one information server. Such a configuration is useful when a very powerful machine such as Sun Enterprise 10K is deployed to host several web sites.

TABLE 3

| Virtual | |
|---|---|
| IP address:Virtual Port Number | Real IP Address:Real Port Number |
| 192.128.111.202:81 | 10.1.1.208:80 |
| 192.128.111.202:12343 | 10.1.1.208:80 |
| 192.128.111.202:27651 | 10.1.1.208:80 |

Note that when there are multiple information servers designated to handle particular content, or when an initial information request arrives that does not specify a specific port number, the load balancer 202 may apply additional load balancing criteria or techniques to determine to which server to send an information request. As examples, the load balancer may take into consideration current CPU utilization for each information server 208-218, or assign information requests Round Robin, or distribute information requests depending on which information server 208-218 current has the fewest connections.

The entries in the mapping table 206 may be updated statically or dynamically. With static updating, the port (or server name or IP address) mappings to the information servers are predefined and setup in the load balancer 202 (e.g., on an EPROM or other reconfigurable memory). With dynamic updating, the contents of the mapping table 206 may change during normal operation of the load balancer 202. Thus, the information servers 208-218 may be assigned to content on an as needed basis.

The modification of the URLs may also be done statically or dynamically. With static modification, all embedded identifiers in the content can be modified at the time of installation of the content on individual information servers. This may be achieved by a content installation tool, during the content installation phase prior to bringing the service online. With dynamic modification, the modification of the embedded information-identifiers in the content is done by the information server software (web server software) and is deferred until the time an information request is actually made by the requestor. Static modification has the advantage of better performance because no processing is done when an information request is handled. Dynamic modification has the advantage of better flexibility since content is not rigidly tied to any particular information server. The content can be moved to any information server on a as-needed basis.

Note that the load balancer 202 may be implemented both as a high level (e.g., layer 7) load balancer and as a lower level (e.g., layer 4) load balancer. The implementation of the load balancer 202 impacts the handling of an initial information request depending on whether layer 7 URL mapping tables are set up in the load balancer 202, whether the information servers have knowledge about what information the other information servers are supposed to serve, and whether content on each information server is replicated across each information server. The implementations discussed below proceed with reference to an initial information request for French content of a website.

If the load balancer 202 implements a layer 7 load balancing process with a preset layer 7 URL mapping table, then each information server 208-218 need only know what content that particular information server has been selected to serve. The load balancer 202 receives the initial information request, checks the layer 7 URL mapping table, and directly sends the initial information request to the appropriate information server 208-218. In this case, although the initial information request incurs the cost of high level processing, the information server rewrites the embedded URLs in the manner detailed above such that subsequent requests for French content come directly to the appropriate information server 208-218 without high level processing. Although content need not be replicated in such an implementation, doing so may provide a degree of redundancy and robustness.

In an alternative implementation, the load balancer 202 does not implement a layer 7 load balancing process. However, each information server 208-218 knows what information every other information server 208-218 is configured to serve and content is replicated on each information server 208-218. In this implementation, the load balancer 202 may send the initial information request to an information server using any of the criteria discussed above (e.g., CPU load) or even randomly. If an information server that is not designated to handle the requested content receives the initial information request, that information server nevertheless responds with the requested content (since the information is replicated across the information servers). However, as described in detail above, the information server also rewrites the embedded URLs such that subsequent information requests are delivered to the appropriate server.

In a third implementation, the load balancer 202 does not implement a layer 7 load balancing process. While each information server 208-218 knows what information every other information server 208-218 is selected to serve, the content is not replicated across the information servers 208-218. If an information server 208-218 that is not designated to handle the requested content receives the initial information request, that information server requests the appropriate information from the designated server and responds with the requested content. In addition, the information server also rewrites the embedded URLs in the information it receives from the designated server such that subsequent information requests are delivered to the appropriate server.

Note also that varying degrees of replication may exist between the information servers 208-218. In one implementation, all the content is replicated. In other implementations, less information is replicated. For example, the data center 200 may only replicate the “higher level” web pages (or, more generally, information) between the information servers 208-218. The replicated “higher level” web pages may be those web pages at or above a preselected level in the hierarchy of web pages or information that comprise a website. For example, the information servers 208-218 may replicate the root page of a website (e.g., www.website.com), or all of the pages of a website reachable from the root page in less than two links.

In an alternate implementation, the load balancer 202 (as opposed to the information servers 208-218) modifies the Information-identifiers. More generally, the modification can be done by a hardware or software entity at any point between (and including) the load balancer 202 and the information servers 208-218. Making the modifications at the load balancer 202 is particularly useful when there are “relative” embedded URLs in the requested content.

Take, for example, the URL <a href=“/x/y/z.html”>. Given requested content returned from www.website.com that has a link <a href /x/y/z.html”>, the web client will open a connection to www.website.com on port 80 and perform a “GET /x/y/z.html HTTP/1.1”. For all the links that contain only the absolute path “/x/y/z.html”, the load balancer 202 returns the absolute URL modified as discussed above, for example, “http://www.abcd.com:9000/x/y/z.html”. The load balancer 202 is particularly suited to performing such modifications, because the information servers 208-218 may not know to which service the requested page belongs.

Another consideration to note is that because incoming traffic connects at a port number (virtual port number) that is different than the port number of the information servers 208-218 (the real port number), the return traffic packets that carry the requested content are modified to include the appropriate port number. When both the incoming and the outgoing traffic goes through the load balancer 202, the load balancer 202 makes the change to the packets. However, in the case where the requested content is sent from the information server to the client directly, the information server will modify the packets.

It is also noted that the actual port numbers that are used at the load balancer 202 and the information servers 208-218 are not limited or constrained. Specifically, the port numbers at which services are started at the information servers 208-218 or the virtual port numbers that are used at the load balancer 202 may vary widely from implementation to implementation, or in a single implementation over time, and are not limited in any way.

The request mapping technique allows a lower level load balancing process to operate, effectively, based on higher level information. The request mapping technique helps a data center achieve much faster request forwarding based on higher level information. In other words, a relatively slow higher level load balancer need not be implemented to forward the information requests. Rather, a relatively fast lower level load balancer may instead quickly direct the information requests to the designated servers based on port numbers assigned higher level meaning (e.g., requested content).

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone. Note also that the implementation may vary between systems. The invention may be implemented with both object-oriented and non-object-oriented programming systems.

What is claimed is:

1. A method in a data processing system comprising the steps of:
receiving from a requester an information request for information content;
determining an information-identifier modification for specifying an information server designated to handle content designated by an information-identifier in the information content;
modifying the information-identifier according to the modification to form a Modified Information-identifier; and
returning the Modified Information-identifier to the requester.

2. The method of claim 1, wherein the step of determining an information-identifier modification comprises the step of determining addition of a port number.

3. The method of claim 2, wherein the Information-identifier comprises a port number, and wherein the step of modifying comprises the step of modifying the port number.

4. The method of claim 1, wherein the Information-identifier comprises an IP address, and wherein the step of modifying comprises the step of changing the IP address.

5. The method of claim 1, wherein the Information-identifier comprises a server name, and wherein the step of modifying comprises the step of changing the server name.

6. The method of claim 1, wherein the step of returning comprises returning the Modified Information-identifier and the information content to the requester.

7. A computer-readable medium containing instructions that cause a data processing system to perform a method, the method comprising the steps of:
receiving from a requester an information request for information content;
determining an information-identifier modification for specifying an information server designated to handle content designated by an information-identifier in the information content;
modifying the information-identifier according to the modification to form a Modified Information-identifier; and
returning the Modified Information-identifier to the requester.

8. The method of claim 7, wherein the step of determining an information-identifier modification comprises the step of determining addition of a port number.

9. The computer-readable medium of claim 7, wherein the step of returning comprises the step of returning the Modified Information-identifier and the information content to the requester.

10. The computer-readable medium of claim 7, wherein the step of modifying comprises the step of modifying a URL embedded in the information content.

11. A data processing system comprising:
a memory comprising a request mapping program, the request mapping program for receiving from a requester an information request for information content, determining an information-identifier modification for specifying an information server designated to handle content designated by an information-identifier in the information content, modifying the information-identifier according to the modification to form a Modified Information-identifier, and returning the Modified Information-identifier to the requester; and
a processor that runs the request mapping program.

12. The data processing system of claim 11, wherein the Modified Information-identifiers comprise a port number specifying the information server.

13. The data processing system of claim 11, wherein the Information-identifier modification comprises changing an IP address.

14. The data processing system of claim 11, wherein the Information-identifier modification comprises changing a server name.

15. The data processing system of claim 11, further comprising a secondary storage device and a content mapping database stored in the secondary storage device.

16. The data processing system of claim 13, wherein the content mapping data base comprises a content entry associated with a predetermined information-identifier modification.

17. A data processing system comprising:
means for receiving from a requester an information request for information content;
means for determining an information-identifier modification for specifying an information server designated to handle content designated by an information-identifier in the information content;
means for modifying the information-identifier according to the modification to form a Modified Information-identifier; and
means for returning the Modified Information-identifier to the requester.

18. A data processing center comprising:
an information server comprising:
a server memory comprising a request mapping program, the request mapping program for receiving from a requester an information request for information content, determining an information-identifier modification for specifying an information server designated to handle content designated by an information-identifier in the information content, modifying the information-identifier according to the modification to form a Modified Information-identifier, and returning the Modified Information-identifier to the requester; and a server processor that runs the request mapping program; and
a load balancer comprising:
a network connection for receiving the information request from the requester;
a server connection coupled to the information server; and
a mapping table comprising an address for the information server.

19. The data processing center of claim 18, wherein the address is an Internet protocol (IP) address.

20. The data processing center of claim 18, wherein the modification comprises adding a port number to the information-identifiers.

21. The data processing center of claim 18, wherein the mapping table comprises a plurality of port numbers, each paired with an address for an associated server.

22. The data processing center of claim 18, wherein the modification comprises modifying a server name.

23. The data processing center of claim 18, wherein the modification comprises modifying an IP address.

24. The data processing center of claim 18, further comprising a plurality of additional information servers connected to the load balancer, and wherein the mapping table comprises, for each additional information server:
at least one preselected port number paired with an address for the additional information server.

25. A computer-readable memory device encoded with a data structure accessed by a request mapping program that is encoded in the computer-readable memory device and that is run by a processor in a data processing system, the data structure comprising entries, each entry comprising a content entry paired with a modification for specifying an information server designated to serve content indicated by the content entry, wherein the request mapping program accesses the data structure to create an Modified Information-identifier modified in accordance with the modification.

26. A method in a data processing system comprising the steps of:
receiving a Uniform Resource Locator (URL) from a remote requester;
identifying content designated by an information-identifier in content requested by the URL;
determining a designated server for serving the content designated;
accessing a mapping database to obtain a selected port number for the designated server;
retrieving the content requested;
adding the selected port number to the information-identifier in the content requested to form Modified Information-identifiers; and
returning the content requested, including the Modified Information-identifiers, to the remote requester.

27. The method of claim 26, wherein the step of receiving comprises the step of receiving the URL from the remote requester through a load balancer.

28. The method of claim 27, wherein the information-identifier comprises a domain name, and wherein the step of adding comprises the step of adding the selected port number after the domain name.

29. The method of claim 27, wherein the information-identifier comprises a domain name, and further comprising the step of modifying the domain name.

30. The method of claim 27, wherein the information-identifier comprises a domain name and an initial port number, and wherein the step of adding comprises the step of changing the initial port number to the selected port number.

31. The method of claim 27, wherein the information-identifier comprises a domain name and an initial port number, and wherein the step of adding comprises the step of changing the initial port number to the selected port number, and further comprising the step of modifying the domain name.
